(19) United States
(12) Patent Application Publication
(10) Pub. No.: US 2005/0193004 A1
(43) Pub. Date: Sep. 1, 2005

(54) Building a case base from log entries

(76) Inventors: John Anthony Cafeo, Farmington, MI (US); Alexander P. Morgan, Birmingham, MI (US); Ronald Michael Lesperance, Troy, MI (US); Andrea M. Simon, Walled Lake, MI (US)

Correspondence Address: KATHRYN A MARRA;General Motors Corporation, Mail Code 482-C23-B21, P.O. Box 300, Detroit, MI, 48265-3000, US

(21) Appl. No.: 10/771,172

(22) Filed: Feb. 3, 2004

(51) Int. Cl. G06F 7/00

(52) U.S. Cl. 707/104.1

(57) ABSTRACT

A method for building a new case or enhancing an established case for inclusion in a case base from log entries. The method includes identifying a current log entry, the current log entry including a status of a current diagnostic process. The method also includes identifying a previous log entry, the previous log entry including a status of either a current diagnostic process or a previous diagnostic process. A determination is made about whether the previous log entry is related to the current log entry. An inquiry is generated to create a link between the previous log entry and the current log entry in response to a determination that the previous log entry is related to the current log entry. The method further includes receiving a request to create a link in response to the inquiry. A link is created between the previous log entry and the current log entry in response to the request resulting in the case.

### BACKGROUND OF THE INVENTION

The present disclosure relates generally to building a case from log entries and, in particular, to a method of linking log entries to build a new case or to enhance an established case for inclusion in a case base.

Case-based reasoning (CBR) attempts to model human reasoning by recalling previous experiences and adapting them to the current situation. In CBR, the primary knowledge source is a memory of stored cases recording prior specific episodes, or issues. A common application of CBR is in diagnostic systems. The notion is that similar prior issues are a useful starting point for solving new issues. Thus, the success of a CBR knowledge system will depend on both the case base (stored memory) as well as the system's ability to recognize and retrieve past cases that will be helpful to solve the current issue. Typically, a case is produced after an issue is solved and includes a description of the symptoms (e.g., fault codes, data plots, visual inspections), a description of the root cause of the issue, and a resolution of the issue. However, the concept of “case” in CBR is more general than this. A “case” in a CBR knowledge system includes any contextual piece of information that describes a particular experience and/or lesson learned that is significant to accomplishing the goals of the reasoner. Therefore, failures may be cases (i.e., attempts to solve a problem that did not lead to a root cause or a resolution) and also fragments. A case is a fragment when the representation of the experience is incomplete in some fundamental way. Fragments can still “teach a lesson,” for example, by indicating that a problem has come up before, even if the solution is omitted. A case has a structure that is relevant to the community of practice (COP) that will be using it, which is what “contextualizes” the knowledge.

When producing a case base it is difficult (even for COP members) to reconstruct all the relevant details of discovering and resolving an issue after the fact. It is difficult because often the people in the COP do not have the time to go back and create a case and still accomplish their primary job. Also, people forget details as time goes on so that cases created after the fact lose the richness that may be key to solving the next issue. Typically a case will be created only after the problem is solved. Although cases which are failures or fragments (as already noted) may be helpful for solving a current problem, these are typically not captured.

### BRIEF DESCRIPTION OF THE INVENTION

One aspect of the invention is a method of building a new case or enhancing an established case for inclusion in a case base from log entries. The method includes identifying a current log entry, the current log entry including a status of a current diagnostic process. The method also includes identifying a previous log entry, the previous log entry including a status of either a current diagnostic process or a previous diagnostic process. A determination is made about whether the previous log entry is related to the current log entry. An inquiry is generated to create a link between the previous log entry and the current log entry in response to a determination that the previous log entry is related to the current log entry. The method further includes receiving a request to create a link in response to the inquiry. A link is created between the previous log entry and the current log entry in response to the request resulting in the case.

In another aspect, a system for building a new case or enhancing an established case for inclusion in a case base from log entries comprises a network and a host system in communication with the network. The host system includes case building application software to implement a method including identifying a current log entry via the network, the current log entry including a status of a current diagnostic process. The method also includes identifying a previous log entry via the network, the previous log entry including a status of either a current diagnostic process or a previous diagnostic process. A determination is made about whether the previous log entry is related to the current log entry. An inquiry is generated to create a link between the previous log entry and the current log entry in response to a determination that the previous log entry is related to the current log entry. The method further includes receiving a request to create a link via the network in response to the inquiry. A link is created between the previous log entry and the current log entry in response to the request resulting in the case.

In a further aspect, a computer program product for building a new case or enhancing an established case for inclusion in a case base from log entries comprises a storage medium readable by a processing circuit and storing instructions for execution by the processing circuit for performing a method including identifying a current log entry, the current log entry including a status of a current diagnostic process. The method also includes identifying a previous log entry, the previous log entry including a status of either a current diagnostic process or a previous diagnostic process. A determination is made about whether the previous log entry is related to the current log entry. An inquiry is generated to create a link between the previous log entry and the current log entry in response to a determination that the previous log entry is related to the current log entry. The method further includes receiving a request to create a link in response to the inquiry. A link is created between the previous log entry and the current log entry in response to the request resulting in the case.

### BRIEF DESCRIPTION OF THE DRAWINGS

Referring to the exemplary drawings wherein like elements are numbered alike in the several FIGURES:

FIG. 1 is a block diagram of an exemplary system for building a case base from log entries;

FIG. 2 depicts an exemplary log database and link database;

FIG. 3 is a flow diagram of an exemplary process for building a case base from log entries;

FIG. 4 is an exemplary log entry user interface screen; and

FIG. 5 is an exemplary case retrieval user interface screen.

### DETAILED DESCRIPTION OF THE INVENTION

A method of building a new case or enhancing an established case for inclusion in a case base from log entries is presented. An embodiment of the present invention is a method to generate cases without authoring them, but rather by linking entries in a diagnostic communications log. The labor of creating a case is reduced from authoring, to linking, an activity requiring much less time and thought. This method of creating cases is possible because the typical work process already includes the ongoing creation of diagnostic log entries. These daily communications (in the form of a common daily logbook or bulletin board) for the COP contain the elements of a case. Each entry is a technical note on the issue-solving process that the members of the COP have deemed important. An entry might be a symptom, a supposition about the issue or solution, a resolution of a problem, other type of technical note or any combination of these. The entries contained in logbooks and bulletin boards are often utilized as an agenda for meetings, as a communication device between shifts and/or as a to-do list for employees.

An exemplary embodiment of the present invention allows the creation of a case by linking log entries. The users link entries during the solution process, as they identify relationships between the entries. As more entries are linked together, a case is built. The links are of different types. For example, one type of link is a reply to an entry. Another type of link specifies a relationship between two entries like “is related to” or “is a symptom of.” These cases are made usable for CBR by allowing a search for similar type symptoms. A number of search strategies, from simple text search to ontology-guided search may be utilized.

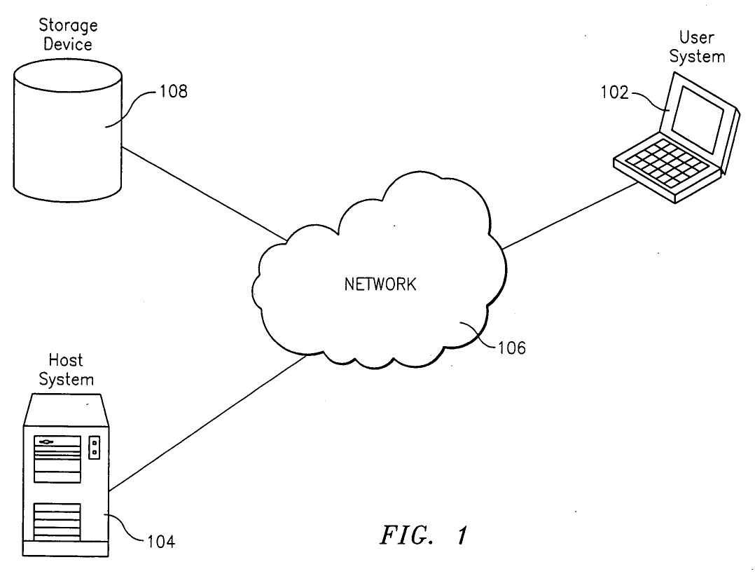

In FIG. 1, a block diagram of an exemplary system for building a case base from log entries is generally shown. The system includes one or more user systems 102 through which users at one or more geographic locations may contact the host system 104. The host system 104 executes the case building application program and the user systems 102 are coupled to the host system 104 via a network 106. Each user system 102 may be implemented using a general-purpose computer executing a computer program for carrying out the processes described herein. The user systems 102 may be personal computers (e.g., a lap top, a personal digital assistant) or host attached terminals. If the user systems 102 are personal computers, the processing described herein may be shared by a user system 102 and the host system 104 (e.g., by providing an applet to the user system 102).

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet and Internet) so that not all user systems 102 are coupled to the host system 104 through the same network. One or more of the user systems 102 and the host system 104 may be connected to the network 106 in a wireless fashion. In one embodiment, the network is the Internet and one or more user systems 102 execute a user interface application (e.g. a web browser) to contact the host system 104 through the network 106 while another user system 102 is directly connected to the host system 104. In another exemplary embodiment, the user system 102 is connected directly (i.e., not through the network 106) to the host system 104 and the host system 104 is connected directly to or contains the storage device 108. In another exemplary embodiment, the user system 102 includes a stand-alone application program to perform case base building and the application data such as the case base ontology. In this embodiment, the application program and data are updated on a periodic basis.

The storage device 108 may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. Information stored in the storage device 108 may be retrieved and manipulated via the host system 104. The storage device 108 includes a log database containing log entries and a link database linking two or more log entries to form a case. The storage device 108 may also include other kinds of data such as information concerning the updating of the link database (e.g., a user identifier, date, and time of update). In an exemplary embodiment, the host system 104 operates as a database server and coordinates access to application data including data stored on storage device 108.

The host system 104 depicted in FIG. 1 may be implemented using one or more servers operating in response to a computer program stored in a storage medium accessible by the server. The host system 104 may operate as a network server (e.g., a web server) to communicate with the user system 102. The host system 104 handles sending and receiving information to and from the user system 102 and can perform associated tasks. The host system 104 may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs to perform case base building functions. Processing may be shared by the user system 102 and the host system 104 by providing an application (e.g., java applet) to the user system 102. Alternatively, the user system 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

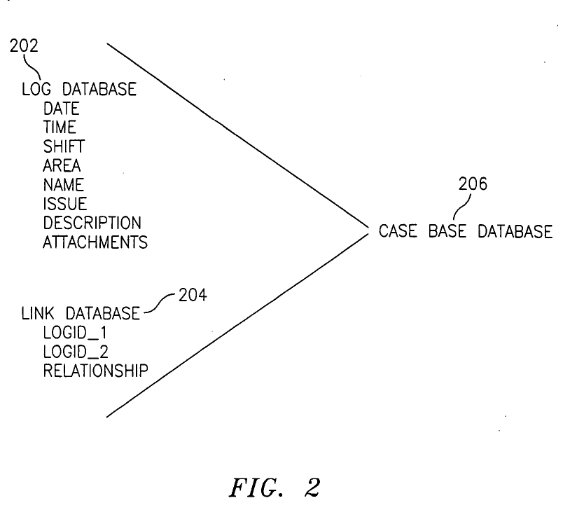

FIG. 2 depicts an exemplary log database 202 and link database 204 that are located on the storage device 108. The combination of the log database 202 and the link database 204 forms the case base database 206. As depicted in FIG. 2, the log entries in the log database 202 include the following attributes: date; time; shift; area (including zone and station); name (e.g., user-id of the user entering the log entry, author of the log entry); issue (including issue detail); description and attachments. The date, time, shift, area and name attribute values may be automatically filled in by the log entry system based on the date and time that the log entry is being entered and based on the work area associated with the name attribute. The issue attribute may be filled in by the user (e.g., a manufacturing engineer, a dimensional engineer) when the user adds the log entry. Key words or terms contained in the issue attribute may be utilized to suggest that similar log entries are related and possibly should be linked. The description attribute in the log database 202 includes text entered by the user to describe the issue and/or possible solutions or actions. The attachments attribute contains one or more pointers to data that user deems relevant to the long entry (e.g., statistical charts, digital photos, videos, graphics). In an exemplary embodiment of the present invention, the attachments contain caption data to describe the information contained in each attachment.

As depicted in FIG. 2, the records in an exemplary link database 204 include a logid_{—}1 attribute that contains enough data (e.g., date, time, name) to uniquely identify one of the records in the log database 202. Similarly, the logid_{—}2 attribute contains enough data (e.g., date, time, name) to uniquely identify a second record in the log database 202. The relationship attribute in the link database 204 defines the type of relationship between the log entries represented by logid_{—}1 and logid_{—}2. In exemplary embodiments of the present invention, the relationship attribute contains data such as: “is a reply to”, “is a continuation of”, “is related to” and “is a symptom of.” The link database 204 may be utilized to group the log entries located in the log database 202 into cases. In this manner a case base that may be utilized for CBR is created from the log entries. It should be realized that when a new entry such as logid_{—}3 is related to logid_{—}2, it is also part of the case including logid_{—}1 through logid_{—}3.

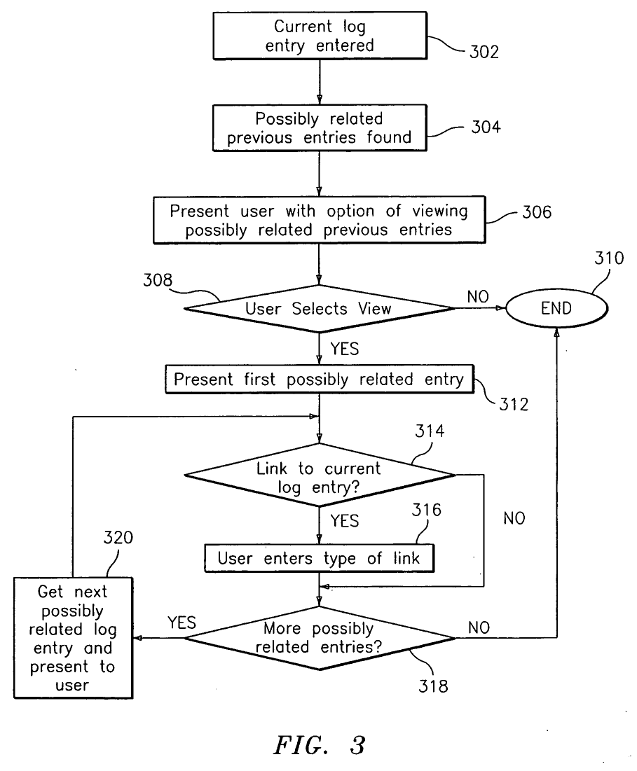

FIG. 3 is a flow diagram of an exemplary process for building a case base from log entries (i.e., entries that are created to communicate a status of an on-going diagnostic process). At step 302, a user enters a current log entry into the case building application. When the user is done entering a current log entry, the case building application, at step 304, finds related previous entries based on data entered by the user into the issue attribute and/or the description attribute. For example, text-mining software may be utilized to search for particular words and phrases within the log entry (e.g., description and attachment captions) based on a list of pre-defined key words and phrases. In an alternate exemplary embodiment, the list of key words and phrases may be defined in an ontology that includes concept words and phrases as well as synonyms. Ontology search software may be utilized to determine previous log entries that are most similar to the current log entry. In an alternate embodiment, related previous entries may be supplied by a user, or a user may conduct an interactive search for related log entries.

In an exemplary embodiment of the present invention, each record in the log database 202 includes a key words and phrases attribute that contains the concept words and phrases from the ontology that are contained in the description and issue attributes. The key words and phrases attribute is utilized by the case building application to determine if a current log entry may be related to a previous log entry. In an alternate exemplary embodiment of the present invention, predefined key words and phrases located in the current log entry are utilized as search parameters for searching the entire (or a portion) of the log database 202 for possibly similar previous log entries.

In alternate exemplary embodiments of the present invention, only the data entered into the issue attributes of log entries are included in the comparison to determine possible related log entries. In addition, the volume of previous log entries searched for similarities with the current log entry may be limited based on criteria such as date created and area. Any text mining method or ontology data mining method known in the art may be utilized to compare data in the current log entry with data in previous log entries for possible matches. The most current possible matches may be presented to the user earlier than older previous log entries because more current previous log entries may be more likely to be related to the current log entry during the problem solving process. As described above, alternate exemplary embodiments of the present invention include having a user enter one or more related previous log entries and/or having a user conduct an interactive search for related log entries.

At step 306, the user is presented with the option of viewing the previous log entries that seem related, as determined at step 304. In addition, the user may be presented with a count of the number of previous entries that seem related. For example, a user interface may contain information about the number of entries and the number of concept, or key, words that were matched. If, at step 308, the user selects not to view the possibly related previous log entries, then the processing of the log entry is complete at step 310. If the user selects, at step 308, to view the possibly related previous log entries, then step 312 is performed. At step 312, the first possibly related previous log entry is presented to the user. At step 314, the user is asked if the current log entry should be linked to the possible related previous log entry. If the user selects yes at step 314, then step 316 is performed and the user enters the type of link between the two log entries. As described previously, in exemplary embodiments of the present invention, the link may be a reply to, a continuation of, related to, or a symptom of a previous log entry. Next, step 318 is performed to determine if there are more possibly related log entries in the log database 202.

If at step 318, it is determined that there are more previous log entries that are possibly related to the current log entry, then processing continues at step 320. Step 320 includes presenting the next possibly related log entry to the user and then processing continues at step 314. If, at step 308, the user selects not to view possibly related previous entries, then step 310 is performed and processing ends. If, at step 314, the user selects not to link the possibly related previous entry, then processing continues a step 318 to determine if there are more possibly related previous entries to present to the user. When, at step 318, it is determined that there are no more possibly related previous entries, then step 310 is performed and processing is complete. In exemplary embodiments of the present invention, “reply” links are created automatically when the current log entry is a reply to a previous log entry.

The exemplary process depicted in FIG. 3 includes having the search for possibly related previous entries at step 304 being performed after the current log entry is complete. In alternate exemplary embodiments of the present invention, the search for previously entered related log entries, at step 304, is performed while the current log entry is being entered. In this alternate exemplary embodiment, the user is presented with the current number of previously entered log entries that are possibly related to the current log entry based on the data entered so far. Instead of the processing ending at step 310, the user continues to enter the current log entry and step 310 causes processing to continue at step 304. In this exemplary embodiment, a pop-up screen may be presented to the user in a lower corner of the log entry screen, with the pop-up screen including current data on the number of previous log entries that are possibly related and, optionally, the number of concept, or key, words that have been matched. For example, the pop-up screen may contain the text: “Seven previous entries have matched three of the concept words that you have entered. Do you want to view them?”

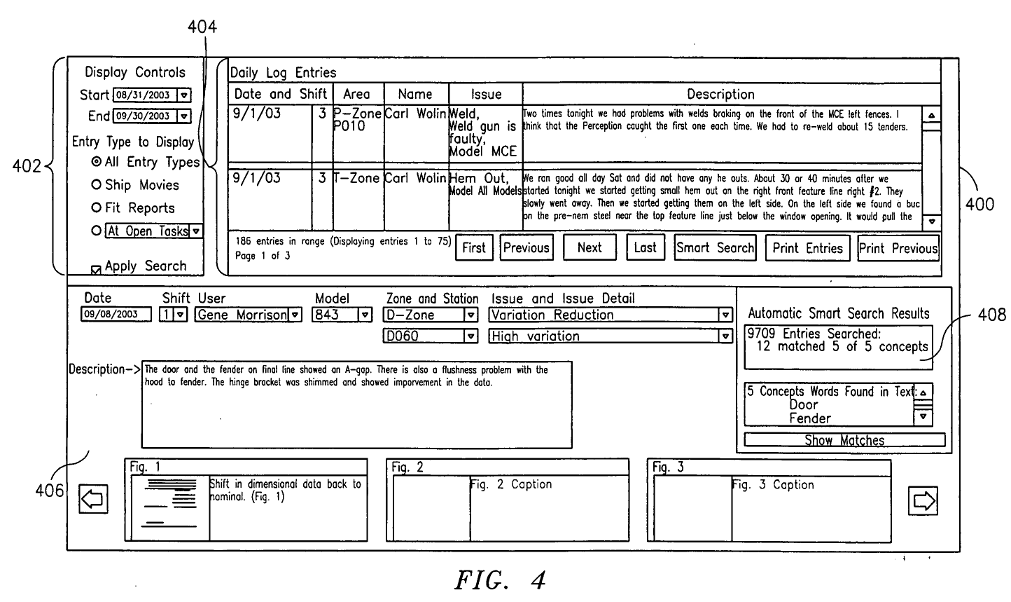

FIG. 4 is an exemplary log entry user interface screen 400 that may be utilized by exemplary embodiments of the present invention. It includes a log entry display control section 402 for determining what previous log entries to display based on criteria such as date ranges, and entry types. The log entry user interface screen 400 depicted in FIG. 4 also includes a previous log entry section 404 where previous log entries matching the criteria in the log entry display control section 402 are displayed. The previous log entries include columns for date and shift, area, name of author, issue and description. Attachments corresponding to previous log entries, if any exist, would also be displayed in the previous log entry section 404.

The log entry user interface screen 400 also includes a current log entry section 406 for entering a current log entry. It includes fields for date, shift, user, model, zone and station, issue and issue detail, description and attachments. Fields that typically contain particular values that are known in advance may be selected by the user from a drop-down menu of choices. As described previously, fields for the date, shift and user attributes may be filled in automatically by the system. The user enters a current log entry in the current log entry section 406 while simultaneously viewing previous log entries. In exemplary embodiments of the present invention, free-form text (e.g., in the description field) is searched for concept words and phrases as it is being entered. When concept words or phrases are located, they are highlighted or underlined in the text. The concept words are the search words, or keywords, that are utilized to find similar previous log entries.

The search results section 408 in the log entry user interface screen includes the number of previous log entries that are possible matches for the current log entry and the number of key words or phrases that have been matched by these previous log entries. In the exemplary embodiment depicted in FIG. 4, the search results section 408 includes a list of the concept words that were located in the text that was entered by the user. The user is also presented with the option of viewing the previous log entries (see step 306 in FIG. 3) that are possible matches for the current log entry in the search results section. The log entry user interface screen 400 depicted in FIG. 4 is one example of a case retrieval user interface screen, other user interfaces are possible to implement the process described in reference to FIG. 3.

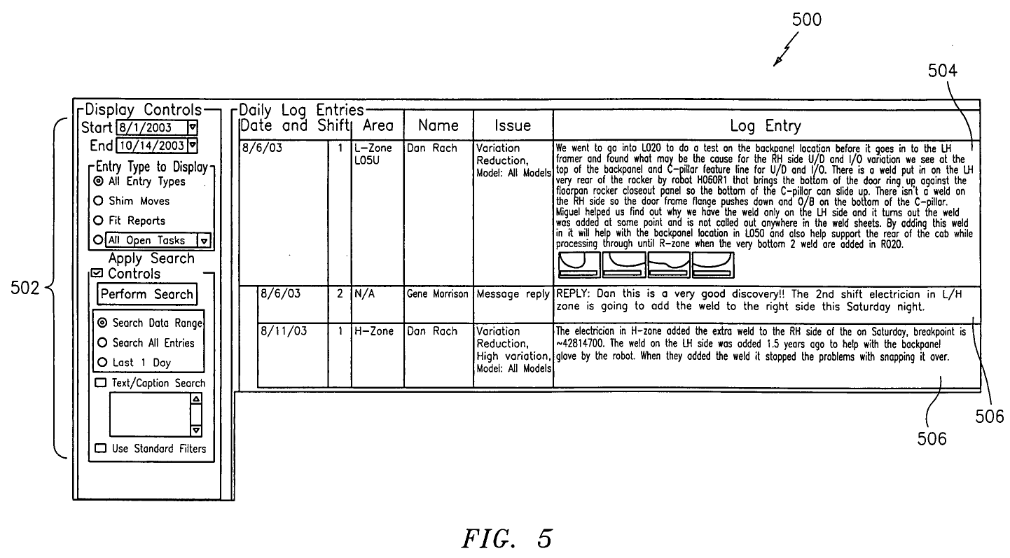

FIG. 5 is an exemplary case retrieval user interface screen 500 that may be utilized by exemplary embodiments of the present invention. It includes a case retrieval display control section 502 that allows the user to select the range of cases in the case base database 206 to be searched. As depicted in the case retrieval display control section 502 of FIG. 5, display controls may include data ranges, entry types (e.g., issues and issue details) and search terms. Also shown in FIG. 5 is a log entry section 504 that has been linked to two related log entry sections 506. By using the case retrieval user interface of FIG. 5, the data collected by entering log entries and linking them together may be retrieved, analyzed and updated by a user. The case retrieval user interface screen 500 depicted in FIG. 5 is one example of a case retrieval user interface screen, other user interfaces are possible to retrieve cases made up of linked log entries.

Exemplary embodiments of the present invention allow a case base to be created in a manner that fits in well with an issue-solving workflow associated with an on-going diagnostic process. This way of authoring cases for inclusion in a case base is part of the COP work process and does not require additional work for the users of the daily log. This can eliminate portions of the knowledge acquisition bottleneck that is common in many case-base or knowledge-based systems. Daily communications in an electronic log are utilized to automatically construct cases. These cases may be used as starting points to solve current issues that are similar in some way. Having the user create the links, as opposed to having the system automatically create the link, may keep unnecessary information out of the case base.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for building a new case or enhancing an established case from log entries for a case base, the method comprising:
identifying a current log entry, the current log entry including a status of an on-going diagnostic process;
identifying a previous log entry, the previous log entry including a status of either a current diagnostic process or a previous diagnostic process;
determining if the previous log entry is related to the current log entry;
generating an inquiry to create a link between the previous log entry and the current log entry in response to a determination that the previous log entry is related to the current log entry;
receiving a request to create the link in response to the inquiry; and
creating the link between the previous log entry and the current log entry in response to the request resulting in the case.

2. The method of claim 1 wherein the current log entry includes a date attribute, a shift attribute, a work area attribute, an author name attribute, an issue attribute and a description attribute.

3. The method of claim 2 wherein the current log entry further includes an attachments attribute.

4. The method of claim 1 wherein the current log entry is part of a daily logbook.

5. The method of claim 1 wherein the current log entry is part of a bulletin board log.

6. The method of claim 1 wherein the current log entry status includes a symptom of an issue.

7. The method of claim 1 wherein the current log entry status includes a supposition about an issue.

8. The method of claim 1 wherein the current log entry status includes a supposition about a solution for an issue.

9. The method of claim 1 wherein the current log entry status includes a resolution for an issue.

10. The method of claim 1 wherein the previous log entry status includes a symptom of an issue.

11. The method of claim 1 wherein the previous log entry status includes a supposition about an issue.

12. The method of claim 1 wherein the previous log entry status includes a supposition about a solution for an issue.

13. The method of claim 1 wherein the previous log entry status includes a resolution for an issue.

14. The method of claim 1 wherein the determining is performed in response to receiving a partial current log entry.

15. The method of claim 1 wherein the determining is performed while the current log entry is being created.

16. The method of claim 1 wherein the determining is responsive to a text search on the previous log entry and the current log entry for pre-defined key words and said determining results in the previous log entry being related to the current log entry if a pre-determined number of matching key words are located.

17. The method of claim 1 wherein the determining is based on user input.

18. The method of claim 1 wherein the determining is responsive to an ontology guided search and comparison between the previous log entry and the current log entry.

19. The method of claim 18 wherein input to the ontology guided search includes pre-defined concept words.

20. The method of claim 1 wherein the link specifies that the current log entry is a reply to the previous log entry.

21. The method of claim 1 wherein the link specifies that the current log entry is related to, is a symptom of, or is a continuation of the previous log entry.

22. The method of claim 1 further comprising receiving a link denial if the user does not respond to the transmitting an option within a pre-selected period of time.

23. A system for building a new case or enhancing an existing case from log entries for a case base, the system comprising:
a network; and
a host system in communication with the network, the host system including case building application software to implement a method comprising:
identifying a current log entry via the network, the current log entry including a status of an on-going diagnostic process;
identifying a previous log entry via the network, the previous log entry including a status of either a current diagnostic process or a previous diagnostic process;
determining if the previous log entry is related to the current log entry;
generating an inquiry to create a link between the previous log entry and the current log entry in response to a determination that the previous log entry is related to the current log entry;
receiving a request via the network to create the link in response to the inquiry; and
creating the link between the previous log entry and the current log entry in response to the request resulting in the case.

24. The system of claim 23 wherein the network is the Internet.

25. A computer program product for building a new case or enhancing an established case from log entries for a case base, the computer program product comprising:
a storage medium readable by a processing circuit and storing instructions for execution by the processing circuit for performing a method comprising:
identifying a current log entry, the current log entry including a status of an on-going diagnostic process;
identifying a previous log entry, the previous log entry including a status of either a current diagnostic process or a previous diagnostic process;
determining if the previous log entry is related to the current log entry;
generating an inquiry to create a link between the previous log entry and the current log entry in response to a determination that the previous log entry is related to the current log entry;
receiving a request to create the link in response to the inquiry; and
creating the link between the previous log entry and the current log entry in response to the request resulting in the case.
